(19) United States
(12) Patent Application Publication
(10) Pub. No.: US 2012/0021658 A1
(43) Pub. Date: Jan. 26, 2012

(54) ELECTRICAL CONNECTOR FOR POWER CONDUCTORS

(75) Inventor: José Alexandre La Salvia, Sao Jose dos Campos (BR)

(73) Assignee: Tyco Electronics Corporation, Berwyn, PA (US)

(21) Appl. No.: 12/841,751

(22) Filed: Jul. 22, 2010

(51) Int. Cl. H01R 11/01; H01R 11/03

(52) U.S. Cl. 439/781; 439/786

(57) ABSTRACT

An electrical connector is provided for power conductors including a main conductor and a tap conductor. The assembly includes an upper conductive member having an upper tap conductor arm configured to engage the tap conductor and an upper main conductor arm configured to engage the main conductor. Each of the upper tap conductor arm and the upper main conductor arm includes a deflectable spring. The electrical connector also includes a lower conductive member separately fabricated from the upper conductive member. The lower conductive member includes a lower tap conductor arm configured to engage the tap conductor and a lower main conductor arm configured to engage the main conductor. Each of the lower tap conductor arm and the lower main conductor arm includes a deflectable spring. The upper and lower tap conductor arms oppose each other and are configured to clamp the tap conductor therebetween. The upper and lower main conductor arms oppose each other and are configured to clamp the main conductor therebetween.

### BACKGROUND OF THE INVENTION

This subject matter described and/or illustrated herein relates generally to electrical connectors, and more particularly, to electrical connectors for mechanically and electrically interconnecting power conductors.

Electrical utility firms constructing, operating, and/or maintaining power distribution and transmission networks utilize connectors to tap main conductors and feed electrical power to tap conductors. The main conductor may be differently sized from the tap conductor, possibly requiring specially designed connector components to connect tap conductors to main conductors. Bolt-on and wedge connectors are two types of connectors that are commonly used to interconnect tap conductors and main conductors.

Bolt-on connectors typically employ die-cast metal connector halves formed as mirror images of one another, sometimes referred to as clam shell connectors. The connector halves define opposing channels that receive the main conductor and the tap conductor. The connector halves are bolted to one another to clamp the metal connector pieces to the conductors. Such bolt-on connectors have been widely accepted in the industry primarily due to their ease of installation, but such connectors are not without disadvantages. Hand tools, such as a torque wrench, are often utilized to tighten the bolt to clamp the connector halves together. Because a high torque is required to tighten the bolt, the quality of the connection is dependent upon the relative strength and skill of the installer, and widely varying quality of connections may result. Additionally, the quality of the connection depends upon the amount of metal-to-metal engagement between the connector pieces and the conductors. For example, a poor connection may result when the engagement surfaces of the connector halves and/or the conductors are oxidized, dirty, or otherwise contaminated. Poorly installed or improperly installed bolt-on connectors can present reliability issues in power distribution and transmission networks. For example, an inadequate amount of torque applied to the bolt may result in a poor electrical connection and/or may enable the bolt to unfasten and thereby let the connector halves come apart. If an excessive amount of torque is applied to the bolt, the elevated mechanical stresses may damage and/or weaken components of the connector.

Bolt-on connectors also suffer from other disadvantages. For example, vibration of bolt-on connectors may unfasten the bolt. Vibrational loads within bolt-on connectors may also damage and/or fatigue components of the connector. Moreover, temperature variations within bolt-on connectors may result in different amounts of expansion and contraction of the various components of the connector as well as the conductors. Such different amounts of expansion and contraction may unfasten the bolt and thereby cause failure of the bolt-on connector. Fatigue and/or damage to components of the bolt-on connector, such as the connector halves and/or the bolt, can also result from such different amounts of expansion and contraction. Such fatigue and/or damage may cause an immediate or future failure of one or more of the components of the connector.

Wedge connectors also suffer from disadvantages. Wedge connectors include a C-shaped channel member that hooks over the main conductor and the tap conductor. A wedge member having channels in opposing sides thereof is driven through the C-shaped member. The wedge member deflects the ends of the C-shaped member, which clamps the conductors between the channels in the wedge member and the ends of the C-shaped member. Wedge connectors tend to be expensive, for example wedge connectors are often more expensive than bolt-on connectors. Additionally, because of the high force needed to drive the wedge member into the C-shaped member, explosive gunpowder cartridges have been developed therefor. However, the explosive gunpowder cartridges are expensive and potentially dangerous to operate. Explosive gunpowder cartridges may also be illegal in some regions. Wedge connectors may also be limited in the range of conductor sizes that a given connector can accommodate. The need for a large inventory of differently sized C-shaped and wedge members may render wedge connectors more expensive and less convenient than is desired.

### BRIEF DESCRIPTION OF THE INVENTION

In one embodiment, an electrical connector is provided for power conductors including a main conductor and a tap conductor. The electrical connector includes an upper conductive member having an upper tap conductor arm configured to engage the tap conductor and an upper main conductor arm configured to engage the main conductor. Each of the upper tap conductor arm and the upper main conductor arm includes a deflectable spring. The electrical connector also includes a lower conductive member separately fabricated from the upper conductive member. The lower conductive member includes a lower tap conductor arm configured to engage the tap conductor and a lower main conductor arm configured to engage the main conductor. Each of the lower tap conductor arm and the lower main conductor arm includes a deflectable spring. The upper and lower tap conductor arms oppose each other and are configured to clamp the tap conductor therebetween. The upper and lower main conductor arms oppose each other and are configured to clamp the main conductor therebetween.

In another embodiment, an electrical connector is provided for power conductors including a main conductor and a tap conductor. The electrical connector includes an upper conductive member having an upper tap conductor arm configured to engage the tap conductor and an upper main conductor arm configured to engage the main conductor. Each of the upper tap conductor arm and the upper main conductor arm includes a deflectable spring. The electrical connector also includes a lower conductive member separately fabricated from the upper conductive member. The lower conductive member includes a lower tap conductor arm configured to engage the tap conductor and a lower main conductor arm configured to engage the main conductor. The upper and lower tap conductor arms oppose each other and are configured to clamp the tap conductor therebetween. The upper and lower main conductor engagement arms oppose each other and are configured to clamp the main conductor therebetween. A threaded fastener connects the upper and lower conductive members.

### BRIEF DESCRIPTION OF THE DRAWINGS

FIG. 1 is a perspective view of an exemplary embodiment of an electrical connector assembly illustrating an electrical connector thereof in a fully clamped position.

FIG. 2 is a cross-sectional view of the electrical connector assembly shown in FIG. 1 taken along line 2-2 of FIG. 1.

FIG. 3 is an elevational view of an exemplary embodiment of the electrical connector of the electrical connector assembly shown in FIGS. 1 and 2.

FIG. 4 is an elevational view of the electrical connector assembly shown in FIGS. 1 and 2 illustrating the electrical connector shown in FIG. 3 in an unclamped position.

FIG. 5 is an elevational view of the electrical connector assembly shown in FIGS. 1, 2, and 4 illustrating the electrical connector shown in FIG. 3 in an intermediate unclamped position.

FIG. 6 is an elevational view of an exemplary embodiment of an electrical connector assembly illustrating use of the electrical connector shown in FIG. 3 with exemplary tap and main conductors that are smaller than the tap and main conductors shown in FIGS. 1 and 2.

FIG. 7 is an elevational view of an exemplary embodiment of an electrical connector assembly illustrating use of the electrical connector shown in FIG. 3 with exemplary tap and main conductors that are smaller than the tap and main conductors shown in FIG. 6.

FIG. 8 is an elevational view of an exemplary embodiment of an electrical connector assembly illustrating use of the electrical connector shown in FIG. 3 with exemplary tap and main conductors that have different sizes than each other.

FIG. 9 is an elevational view of the electrical connector assembly shown in FIG. 8 illustrating the electrical connector shown in FIG. 3 in a fully clamped position.

### DETAILED DESCRIPTION OF THE INVENTION

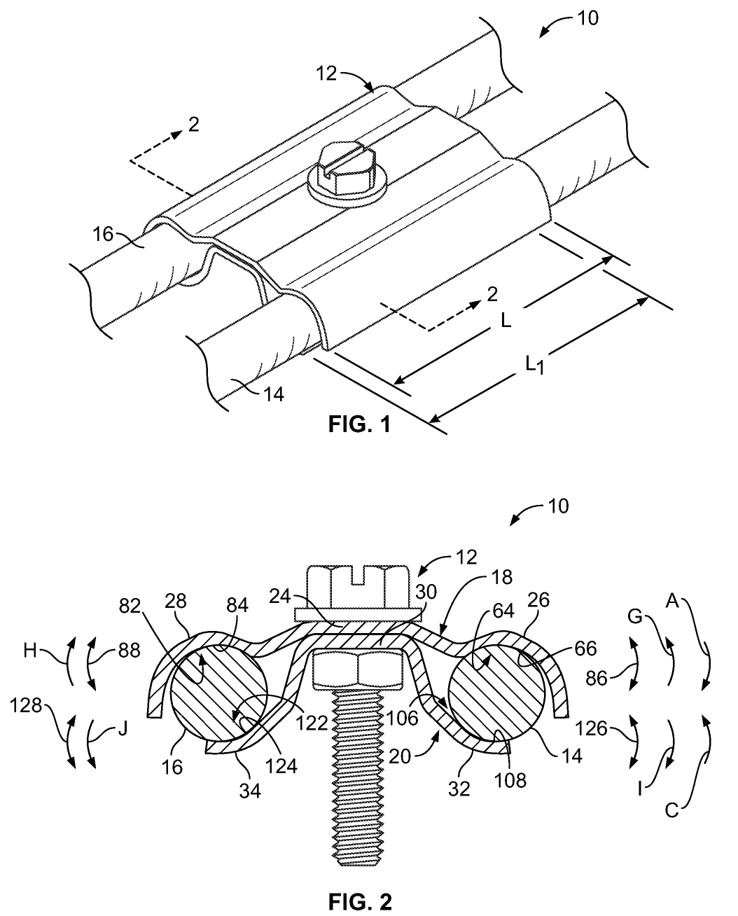

FIG. 1 is a perspective view of an exemplary embodiment of an electrical connector assembly 10. FIG. 2 is a cross-sectional view of the connector assembly 10 taken along line 2-2 of FIG. 1. Referring now to FIGS. 1 and 2, the electrical connector assembly 10 includes an electrical connector 12 that is adapted for use as a tap connector for connecting a tap conductor 14 to a main conductor 16. The tap conductor 14 and the main conductor 16 may be conductors of any circuit, network, system, and/or the like having any current levels, voltage levels, formats (e.g., AC and/or DC), and/or the like. For example, the tap and main conductors 14 and 16, respectively, may be conductors of a utility power distribution network, a utility power transmission network, a DC circuit, and/or the like. When installed to the tap conductor 14 and the main conductor 16, the electrical connector 12 provides electrical connectivity between the main conductor 16 and the tap conductor 14, for example, to feed electrical power from the main conductor 16 to the tap conductor 14.

In the exemplary embodiment, the tap conductor 14 and the main conductor 16 each include a generally cylindrical shape. But, the tap conductor 14 may alternatively include any other shape. Similarly, the main conductor 16 may alternatively include any other shape. As shown herein for simplicity, each of the tap conductor 14 and the main conductor 16 is optionally a solid wire. Alternatively, the tap conductor 14 and/or the main conductor 16 is formed from a plurality of strands of wire. In some alternative embodiments, the tap conductor 14 and/or the main conductor 16 may include an insulation layer (not shown). The tap conductor 14 and the main conductor 16 may be of the same wire gage or different wire gage. The circuit, network, system, and/or the like may include a number of main conductors 16 of the same or different wire gage, and a number of tap conductors 14 of the same or different wire gage. As will be described below, the electrical connector 12 is adapted to accommodate a range of wire gages for each of the tap conductor 14 and the main conductor 16.

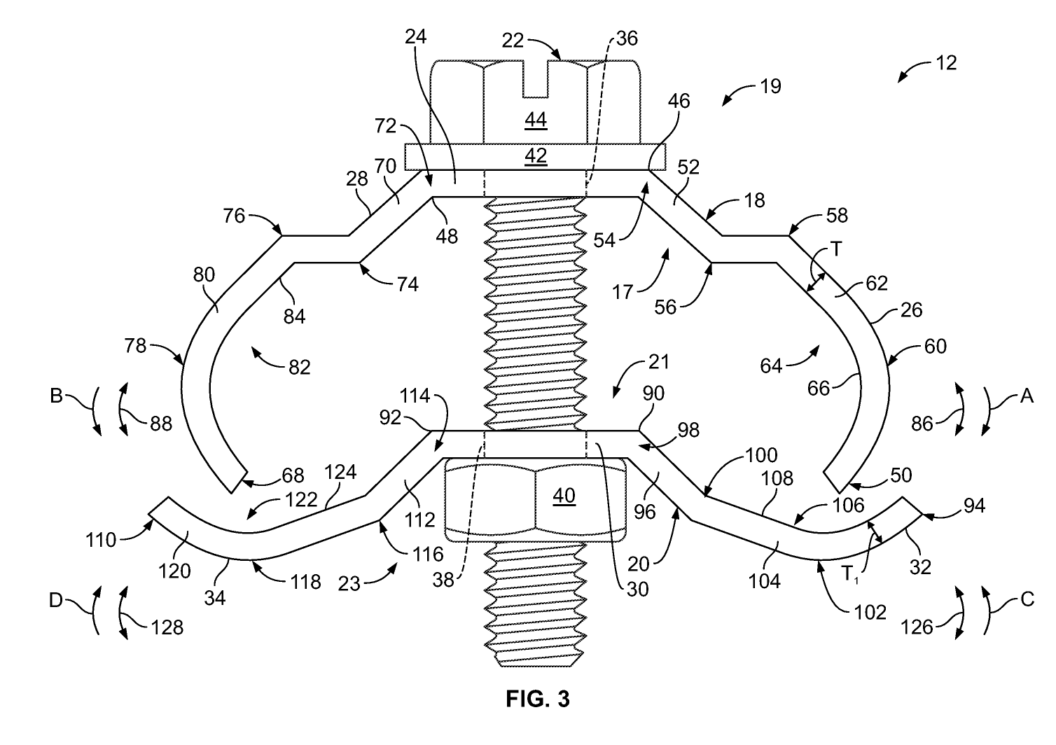

FIG. 3 is an elevational view of the electrical connector 12. The electrical connector 12 includes an upper conductive member 18, a lower conductive member 20, and a fastener 22 that couples the upper conductive member 18 and the lower conductive member 20 together. The upper conductive member 18 has a clamping side 17 and an opposite exterior side 19. The upper conductive member 18 includes an upper central plate 24 and upper tap and main conductor arms 26 and 28, respectively, that extend outwardly from the upper central plate 24. Similarly, the lower conductive member 20 has a clamping side 21 and an opposite exterior side 23. The lower conductive member 20 includes a lower central plate 30 and lower tap and main conductor arms 32 and 34, respectively, that extend outwardly from the lower central plate 30. The upper and lower tap conductor arms 26 and 32, respectively, oppose each other and are configured to clamp the tap conductor 14 therebetween. The upper and lower main conductor arms 28 and 34, respectively, oppose each other and are configured to clamp the main conductor 16 therebetween.

Both the upper and lower central plates 24 and 30 include optional openings 36 and 38 that receive the fastener 22 therethrough. In the exemplary embodiment, the fastener 22 is a threaded member inserted through the openings 36 and 38 of the upper and lower central plates 24 and 30, respectively. The exemplary embodiment of the fastener 22 also includes a nut 40 and a washer 42. The nut 40 engages the thread of the fastener 22 to hold the upper and lower conductive members 18 and 20, respectively, between a head 44 of the fastener 22 and the nut 40. As will described below, tightening of the fastener 22 draws the upper and lower conductive members 18 and 20, respectively, together.

Although not shown, a washer may be used with the nut 40 in addition or alternatively to the washer 42 used with the head 44. In addition or alternatively to the nut 40, one or both of the openings 36 and 38 of the upper and lower central plates 24 and 30, respectively, may be threaded. Moreover, the orientation of the fastener 22 as shown herein may be reversed, whether or not the fastener 22 includes the nut 40. In other words, the fastener 22 may extend through the openings 36 and 38 such that that head 44, or more specifically the washer 42 if included, is engaged with the lower conductive member 20 instead of the upper conductive member 18. Although the exemplary embodiment of the electrical connector 12 includes only a single fastener 22, alternatively the electrical connector 12 may include more than one fastener 22. Moreover, while the specific threaded fastener elements 22, 40, 42, and 44 are illustrated and described herein, it is understood that other known fasteners may additionally or alternatively be used to couple and draw the upper and lower conductive member 18 and 20, respectively, together.

The upper central plate 24 of the upper conductive member 18 extends a width between a pair of opposite edges 46 and 48. The upper tap conductor arm 26 extends outwardly from the edge 46 of the upper central plate 24, while the upper main conductive arm 28 extends outwardly from the edge 48. The upper tap conductor arm 26 extends outwardly from the upper central plate 24 to a tip 50. The upper tap conductor arm 26 includes a shoulder segment 52 that extends outwardly from the upper central plate 24. The shoulder segment 52 extends from the upper central plate 24 at an intersection 54 between the upper tap conductor arm 26 and the edge 46 of the upper central plate 24. In the exemplary embodiment, the intersection 54 is defined by a bend such that the shoulder segment 52 of the upper tap conductor arm 26 is angled relative to the upper central plate 24. The shoulder segment 52 may extend at any angle relative to the upper central plate 24. The upper tap conductor arm 26 also includes bends 56, 58, and 60. Each of the bends 56, 58, and 60 may have any angle. The bend 56 defines an intersection between the shoulder segment 52 of the upper tap conductor arm 26 and a channel segment 62 of the upper tap conductor arm 26. The bends 58 and 60 form a channel 64 of the channel segment 62 of the upper tap conductor arm 26. The channel 64 is configured to receive the tap conductor 14 therein. The channel segment 62 is reminiscent of a hook and/or a cradle in the exemplary embodiment.

The channel segment 62 of the upper tap conductor arm 26 includes an engagement surface 66. At least a portion of the engagement surface 66 engages the tap conductor 14 when the tap conductor 14 is clamped between the upper and lower tap conductor arms 26 and 32, respectively. As will be described below, the channel 64 is configured to receive a range of differently sized tap conductors such that the upper tap conductor arm 26 is configured to cooperate with the lower tap conductor arm 32 to clamp a range of differently sized tap conductors. Accordingly, the upper tap conductor arm 26 is configured to clamp a range of differently sized tap conductors. The amount and specific portions of the engagement surface 66 that engage the tap conductor 14 is dependent upon the size of the particular tap conductor being clamped between the upper and lower tap conductor arms 26 and 32, respectively. The intersection 54 may be referred to herein as an “upper intersection”.

The upper main conductor arm 28 extends outwardly from the edge 48 of the upper central plate 24 to a tip 68. The upper main conductor arm 28 includes a shoulder segment 70 that extends outwardly from the upper central plate 24 at an intersection 72 between the upper main conductor arm 28 and the edge 48 of the upper central plate 24. The exemplary embodiment of the intersection 72 is defined by a bend such that the shoulder segment 70 of the upper main conductor arm 28 is angled relative to the upper central plate 24. The shoulder segment 70 may extend at any angle relative to the upper central plate 24. The upper main conductor arm 28 also includes bends 74, 76, and 78, each of which may have any angle. The bend 74 defines an intersection between the shoulder segment 70 of the upper main conductor arm 28 and a channel segment 80 of the upper main conductor arm 28. A channel 82 of the channel segment 80 is formed by the bends 76 and 78. The channel 82 is configured to receive the main conductor 16 therein. In the exemplary embodiment, the channel segment 80 is reminiscent of a hook and/or a cradle. The intersection 72 may be referred to herein as an “upper intersection”.

At least a portion of an engagement surface 84 of the channel segment 80 of the upper main conductor arm 28 engages the main conductor 16 when the main conductor 16 is clamped between the upper and lower main conductor arms 28 and 34, respectively. The channel 82 is configured to receive a range of differently sized main conductors, and the upper main conductor arm 28 is configured to cooperate with the lower main conductor arm 34 to clamp a range of differently sized main conductors, as will be described below. Accordingly, the upper main conductor arm 28 is configured to clamp a range of differently sized main conductors. The amount and specific portions of the engagement surface 84 that engage the main conductor 16 is dependent upon the size of the particular main conductor being clamped between the upper and lower main conductor arms 28 and 34, respectively.

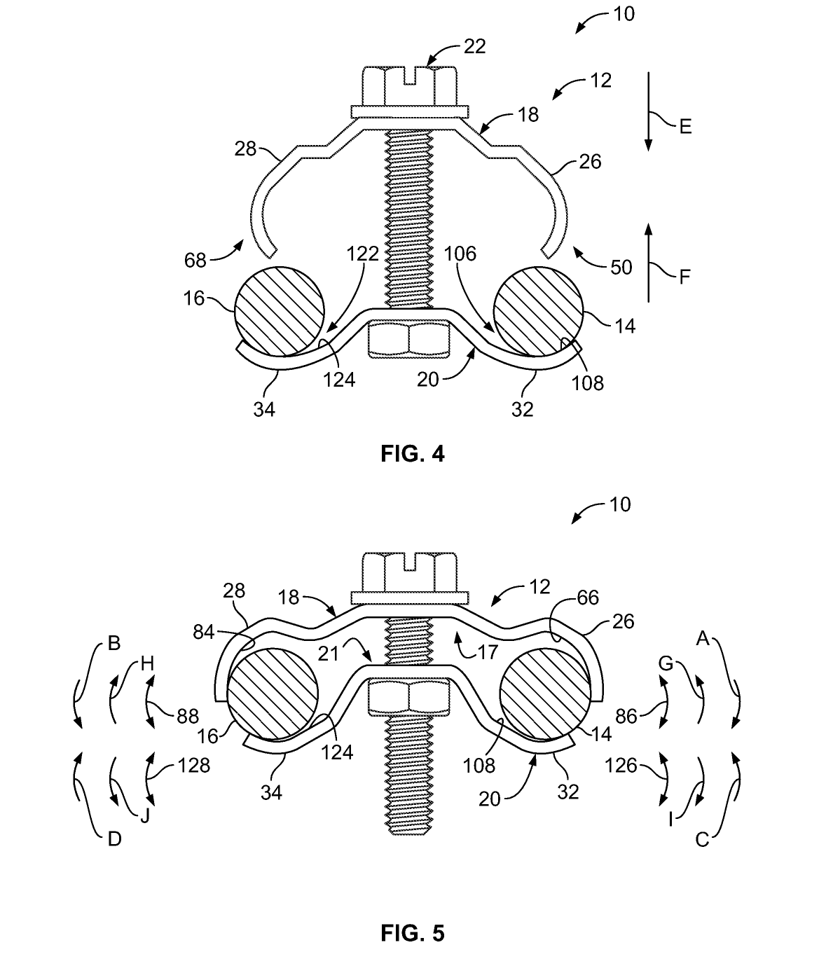

Optionally, the upper tap and main conductor arms 26 and 28 are deflectable springs that are movable between normal positions and deflected positions. Exemplary normal positions of the upper tap and main conductor arms 26 and 28, respectively, are shown in FIG. 3. Exemplary deflected positions of the arms 26 and 28 are shown in FIGS. 5-9. In the exemplary embodiment, the upper tap and main conductor arms 26 and 28, respectively, are movable relative to the upper central plate 24 along respective arcs 86 and 88 centered at the respective intersections 54 and 72. The angle of the bends at the intersections 54 and 72 therefore changes, at least slightly, during movement of the upper tap and main conductor arms 26 and 28, respectively. Because the upper tap and main conductor arms 26 and 28, respectively, are springs, the arms 26 and 28 are each resilient. A biasing force acting in the respective directions A and B is thus exerted against movement of the arms 26 and 28 from the normal positions to the deflected positions. In the exemplary normal positions shown in FIG. 3, the upper conductive member 18 has a concave shape as viewed from the clamping side 17 thereof.

The angle of the bends 56, 58, and/or 60 of the upper tap conductor arm 26 may or may not change during movement of the arm 26. In some embodiments, and as will be described below, the angle of the bends 56, 58, and/or 60 changes during movement of the upper tap conductor arm 26 to conform the size and/or shape of at least a portion of the arm 26 (e.g., the size and/or shape of at least a portion of the channel 64) to the size and/or shape of the particular tap conductor being clamped by the arm 26. Whether or not the angle of the bends 56, 58, and/or 60 changes, as well as the amount of change, may depend on the size and/or shape of the particular tap conductor being clamped by the arm 26. Similar to the upper tap conductor arm 26, the angle of any of the bends 74, 76, and/or 78 of the upper main conductor arm 28 may or may not change during movement of the arm 28. The angle of the bends 74, 76, and/or 78 optionally changes during movement of the upper main conductor arm 28 to conform the size and/or shape of at least a portion of the arm 28 (e.g., the size and/or shape of at least a portion of the channel 82) to the size and/or shape of the particular main conductor being clamped by the arm 28. Whether or not the angle of the bends 74, 76, and/or 78 changes, as well as the amount of change, may depend on the size and/or shape of the particular main conductor being clamped by the arm 28.

The lower central plate 30 of the lower conductive member 20 extends a width between a pair of opposite edges 90 and 92, with the lower tap conductor arm 32 extending outwardly from the edge 90. The lower tap conductor arm 32 extends outwardly to a tip 94 and includes a shoulder segment 96 that extends outwardly from the lower central plate 30. The shoulder segment 96 extends from the lower central plate 30 at an intersection 98 between the lower tap conductor arm 32 and the edge 90 of the lower central plate 30. The exemplary embodiment of the intersection 98 is defined by a bend such that the shoulder segment 96 of the lower tap conductor arm 32 is angled relative to the lower central plate 30. The shoulder segment 96 may extend at any angle relative to the lower central plate 30. The lower tap conductor arm 32 also includes bends 100 and 102, each of which may have any angle. The bend 100 defines an intersection between the shoulder segment 96 of the lower tap conductor arm 32 and a channel segment 104 of the lower tap conductor arm 32. The bends 102 and 104 form a channel 106 of the channel segment 104. The channel 106 is configured to receive the tap conductor 14 therein and, in the exemplary embodiment, is reminiscent of a hook and/or a cradle. The intersection 98 may be referred to herein as a “lower intersection”.

The channel segment 104 of the lower tap conductor arm 32 includes an engagement surface 108. At least a portion of the engagement surface 108 engages the tap conductor 14 when the tap conductor 14 is clamped between the upper and lower tap conductor arms 26 and 32, respectively. As will be described below, the channel 106 is configured to receive a range of differently sized tap conductors, and the lower tap conductor arm 32 is configured to cooperate with the upper tap conductor arm 26 to clamp a range of differently sized tap conductors. The lower tap conductor arm 32 is therefore configured to clamp a range of differently sized tap conductors. The amount and specific portions of the engagement surface 108 that engage the tap conductor 14 is dependent upon the size of the particular tap conductor being clamped between the upper and lower tap conductor arms 26 and 32, respectively.

The lower main conductive arm 34 extends outwardly from the edge 92 of the lower central plate 30 and includes a tip 110. A shoulder segment 112 of the lower main conductor arm 34 extends outwardly from the lower central plate 30 at an intersection 114 between the lower main conductor arm 34 and the edge 92 of the lower central plate 30. In the exemplary embodiment, the intersection 114 is defined by a bend such that the shoulder segment 112 of the lower main conductor arm 34 is angled relative to the lower central plate 30. The shoulder segment 112 may have any angle relative to the lower central plate 30. Bends 116 and 118 also extend within the lower main conductor arm 34. The bends 116 and 118 may each have any angle. The lower main conductor arm 34 includes a channel segment 120 that extends outwardly from the shoulder segment 112. The bend 116 defines an intersection between the shoulder segment 112 and the channel segment 120 of the lower main conductor arm 34. The bend 118 defines a channel 122 of the channel segment 120. The channel 122 is configured to receive the main conductor 16 therein. In the exemplary embodiment, the channel segment 120 is reminiscent of a hook and/or a cradle. The intersection 114 may be referred to herein as a “lower intersection”.

The channel segment 120 of the lower main conductor arm 34 includes an engagement surface 124 that engages the main conductor 16 when the main conductor 16 is clamped between the upper and lower main conductor arms 28 and 34, respectively. The channel 122 is configured to receive a range of differently sized main conductors, and the lower main conductor arm 34 is configured to cooperate with the upper main conductor arm 28 to clamp a range of differently sized main conductors. Accordingly, the lower main conductor arm 34 is configured to clamp a range of differently sized main conductors. The amount and specific portions of the engagement surface 124 that engage the main conductor 16 is dependent upon the size of the particular main conductor being clamped between the upper and lower main conductor arms 28 and 34, respectively.

The lower tap and main conductor arms 32 and 34 are optionally deflectable springs that are movable between normal positions and deflected positions. FIG. 3 illustrates exemplary normal positions of the lower tap and main conductor arms 26 and 28. FIGS. 5-9 illustrate exemplary deflected positions of the arms 32 and 34. In the exemplary embodiment, the lower tap and main conductor arms 32 and 34, respectively, are movable relative to the lower central plate 30 along respective arcs 126 and 128 centered at the respective intersections 98 and 114. Accordingly, the angle of the bends at the intersections 98 and 114 changes, at least slightly, during movement of the lower tap and main conductor arms 32 and 34, respectively. Because the lower tap and main conductor arms 32 and 34, respectively, are springs, the arms 32 and 34 are each resilient. Accordingly, a biasing force acting in the respective directions C and D is exerted against movement of the arms 32 and 34 from the normal positions to the deflected positions. In the exemplary normal positions shown in FIG. 3, the lower conductive member 20 has a convex shape as viewed from the clamping side 21 thereof.

During movement of the lower tap conductor arm 32, the angle of the bends 100 and/or 102 may or may not change. In some embodiments, the angle of the bends 100 and/or 102 changes during movement of the lower tap conductor arm 32 to conform the size and/or shape of at least a portion of the arm 32 (e.g., the size and/or shape of at least a portion of the channel 106) to the size and/or shape of the particular tap conductor being clamped by the arm 32. Whether or not the angle of the bends 100 and/or 102 changes, as well as the amount of change, may depend on the size and/or shape of the particular tap conductor being clamped by the arm 32. The angle of any of the bends 116 and/or 118 of the lower main conductor arm 34 may or may not change during movement of the arm 34. Optionally, the angle of the bends 116 and/or 118 changes during movement of the lower main conductor arm 34 to conform the size and/or shape of at least a portion of the arm 34 (e.g., the size and/or shape of at least a portion of the channel 122) to the size and/or shape of the particular main conductor being clamped by the arm 34. Whether or not the angle of the bends 116 and/or 118 changes, as well as the amount of change, may depend on the size and/or shape of the particular main conductor being clamped by the arm 34.

The upper and lower conductive members 18 and 20, respectively, are separately fabricated from one other or otherwise formed into discrete connector components that are assembled together as shown and/or described herein. The upper and lower conductive members 18 and 20, respectively, may each be fabricated using any suitable method, process, means, and/or the like, such as, but not limited to, cutting, machining, etching, stamping, forming, casting, molding, and/or the like. In one exemplary embodiment, the upper and lower conducted members 18 and 20, respectively, are each stamped and formed from a sheet or reel of material. In the exemplary embodiment, each of the upper and lower conductive members 18 and 20, respectively, is shown as having a respective thicknesses T and T₁ that is uniform throughout the member 18 and 20. Alternatively, the upper conductive member 18 and/or the lower conductive member 20 may include a non-uniform thickness. While exemplary shapes of the upper and lower conductive members 18 and 20, respectively, are been shown and described herein, it is recognized that the conductive members 18 and 20 may each be alternatively shaped in other embodiments. Optionally, a corrosion inhibitor coating is applied to at least a portion of the upper conductive member 18 and/or at least a portion of the lower conductive member 20 to reduce corrosion of the conductive members 18 and/or 20.

As illustrated in FIG. 1, each of the bends 56, 58, 60, 74, 76, and 78 of the upper conductive member 18 extends parallel to a length L of the member 18. Optionally, the upper conductive member 18 includes one or more bends (not shown) that extends perpendicular or oblique to the length L of the member 18, which may increase a structural rigidity of at least a portion of the member 18. Similarly, the lower conductive member 20 optionally includes one or more bends (not shown) that extends perpendicular or oblique to the length L₁ of the member 20, which may increase a structural rigidity of at least a portion of the member 20.

FIG. 4 is an elevational view of the electrical connector assembly 10 illustrating the electrical connector 12 in an unclamped position. In the unclamped position shown in FIG. 4, the upper and lower tap conductor arms 26 and 32, respectively, and the upper and lower main conductor arms 28 and 34, respectively, are in the normal, non-deflected positions. To clamp the tap and main conductors 14 and 16, respectively, the tap conductor 14 is positioned within the channel 106 of the lower tap conductor arm 32 such that the tap conductor 14 rests against the engagement surface 108 of the arm 32. The main conductor 16 is positioned within the channel 122 of the lower main conductor arm 34 such that the main conductor 16 rests against the engagement surface 124 of the arm 34. The upper conductive member 18 is spaced apart from the lower conductive member 20 and the upper tap and main conductor arms 28 and 34, respectively, are disengaged from the tap and main conductors 14 and 16, respectively.

The fastener 22 is then tightened to draw the upper and lower conductive members 18 and 20, respectively, closer together. Specifically, tightening of the fastener 22 moves the upper conductive member 18 in the direction of the arrow E relative to the lower conductive member 20. The lower conductive member 20 moves in the direction of the arrow F relative to the upper conductive member 18 upon tightening of the fastener 22. As the conductive members 18 and 20 move closer together, the upper tap conductor arm 26 of the upper conductive member 18 engages the tap conductor 14, and the upper main conductor arm 28 engages the main conductor 16. More particularly, in the exemplary embodiment, the tips 50 and 68 of the arms 26 and 32, respectively, engage the tap and main conductors 14 and 16, respectively. But, any other portion of the arms 26 and 32 may engage the tap and main conductors 14 and 16, respectively, in addition or alternative to the respective tips 50 and 68.

FIG. 5 is an elevational view of the electrical connector assembly 10 illustrating the electrical connector 12 in an intermediate unclamped position. The upper and lower conductive members 18 and 20, respectively, are shown in FIG. 5 after the being partially deflected by the engagement with the tap conductor 14 and the main conductor 16. More particularly, the upper tap conductor arm 26 has been moved along the arc 86 in a direction G that is against the direction A of the biasing force of the arm 26. The upper main conductor arm 28 has been moved along the arc 88 in a direction H that is against the direction B of the biasing force of the arm 28. The lower tap conductor arm 32 has been moved along the arc 126 in a direction I that is against the direction C of the biasing force of the arm 32, while the lower main conductor arm 34 has been moved along the arc 128 in a direction J that is against the direction D of the biasing force of the arm 34.

As can be seen in FIG. 5, the movement of the arms 26 and 28 has spread the engagement surfaces 66 and 84, respectively, further apart from each other, which decreases the concavity (as viewed from the clamping side 17) of the upper conductive member 18. The movement of the arms 32 and 34 has spread the engagement surfaces 108 and 124, respectively, further apart from each other. The movement of the arms 32 and 34 increases the convexity (as viewed from the clamping side 21) of the lower conductive member 20. As the engagement surfaces 66 and 108 of the upper and lower tap conductor arms 26 and 32, respectively, engage the tap conductor 14, friction between the engagement surfaces 66 and 108 and the tap conductor 14 provides a wiping contact interface that facilitates removing oxidation and thereby providing adequate electrical connectivity with the tap conductor 14. Similarly, friction between the engagement surfaces 84 and 124 and the main conductor 16 provides a wiping contact interface that facilitates removing oxidation and thereby providing adequate electrical connectivity with the main conductor 16. Optionally, one or more ridges (not shown), bumps (not shown), points (not shown), or other texture (not shown) is formed within the engagement surfaces 66, 84, 108, and/or 124 to increase the friction between the surface 66, 84, 108, and/or 124 and the corresponding tap conductor 14 or main conductor 16.

Referring again to FIG. 2, the fully clamped position of the electrical connector 10 is shown. In the fully clamped position, the tap conductor 14 is engaged between the upper and lower tap conductor arms 26 and 32, respectively, and the main conductor 16 is engaged between the upper and lower main conductor arms 28 and 34, respectively. The electrical connector 10 thereby clamps the main conductor 16 and the tap conductor 14 in a side-by-side relationship, as shown in FIG. 2. The tap conductor 14 is engaged with the engagement surfaces 66 and 108 of the arms 26 and 32, respectively, such that the tap conductor 14 is electrically connected to the upper and lower conductive members 18 and 20, respectively. The main conductor 16 is electrically connected to the upper and lower conductive members 18 and 20, respectively, via the engagement of the main conductor 16 with the engagement surfaces 84 and 124 of the arms 28 and 34, respectively. Accordingly, in the fully clamped position, the electrical connector 12 electrically connects the tap conductor 14 to the main conductor 16.

The upper and lower conductive members 18 and 20, respectively, are shown in FIG. 2 after the being fully deflected by the engagement with the tap conductor 14 and the main conductor 16. More particularly, the upper tap and main conductor arms 26 and 32, respectively, have each been moved along the respective arcs 86 and 88 in the respective directions G and H to the fully deflected positions shown in FIG. 2. Similarly, the lower tap and main conductor arms 28 and 34, respectively, have each been moved along the respective arcs 126 and 128 in the respective directions I and J to the fully deflected positions shown in FIG. 2. As should be apparent from a comparison of FIGS. 2 and 4, each of the upper conductive member 18 and the lower conductive member 20 has substantially changed shape between the unclamped position shown in FIG. 4 and the fully clamped position shown in FIG. 2.

In the fully deflected positions, the biasing forces of the upper and lower tap conductor arms 26 and 32 impart a clamping force on the tap conductor 14, and the biasing forces of the upper and lower main conductor arms 28 and 34 impart a clamping force on the main conductor 16. The clamping forces ensure adequate electrical connectivity between the tap conductor 14 and the main conductor 16. Additionally, the biasing forces provide some tolerance for deformation or compressibility of the tap and/or main conductors 14 and 16, respectively, over time. For example, the upper and/or lower tap conductor arms 26 and 32 may partially return in the respective directions A and C if the tap conductor 14 deforms due to compression forces.

As should be apparent from a comparison of FIGS. 2 and 4, in the fully clamped position, each of the upper and lower tap conductor arms 26 and 32, respectively, has conformed to a size and/or shape of the tap conductor 14. Specifically, the angle of the bends 56, 58, and/or 60 (FIG. 3) of the upper tap conductor arm 26 has changed to at least partially conform the size and/or shape of the channel 64 to the size and/or shape of the tap conductor 14. The angle of the bends 100 and/or 102 (FIG. 3) of the lower tap conductor arm 32 has changed to at least partially conform the size and/or shape of the channel 106 to the size and/or shape of the tap conductor 14. The upper and lower tap conductor arms 26 and 32, respectively, thereby cooperate to conform to the size and/or shape of the tap conductor 14. Similar to the arms 26 and 32, each of the upper and lower main conductor arms 28 and 34, respectively, has conformed to a size and/or shape of the main conductor 16. More particularly, the angle of the bends 74, 76, and/or 78 (FIG. 3) of the arm 28 has changed to at least partially conform the size and/or shape of the channel 82 to the size and/or shape of the main conductor 16, and the angle of the bends 116 and/or 118 (FIG. 3) of the arm 34 has changed to at least partially conform the size and/or shape of the channel 122 to the size and/or shape of the main conductor 16. The upper and lower main conductor arms 28 and 34, respectively, thereby cooperate to conform to the size and/or shape of the main conductor 16.

When the upper and lower conductive members are fully clamped together as shown in FIG. 2, the central plates 24 and 30 engage each other to form a displacement stop that defines and limits a final displacement relation between the upper and lower conductive members 18 and 20, respectively. The displacement stop defines a final mating position between the conductive members 18 and 20. Optionally, the displacement stop may be created from a stand off provided on one or both of the central plates 24 and 30. Unlike at least some known connectors, torque requirements for tightening of the fastener 22 are not required to satisfactorily install the electrical connector 12 to the tap and main conductors 14 and 16, respectively. Rather, the displacement stop allows the fastener 22 to be continuously tightened until the central plates 24 and 30 are fully seated against each other independent of, and without regard for, any normal forces on the tap and main conductors 14 and 16, respectively.

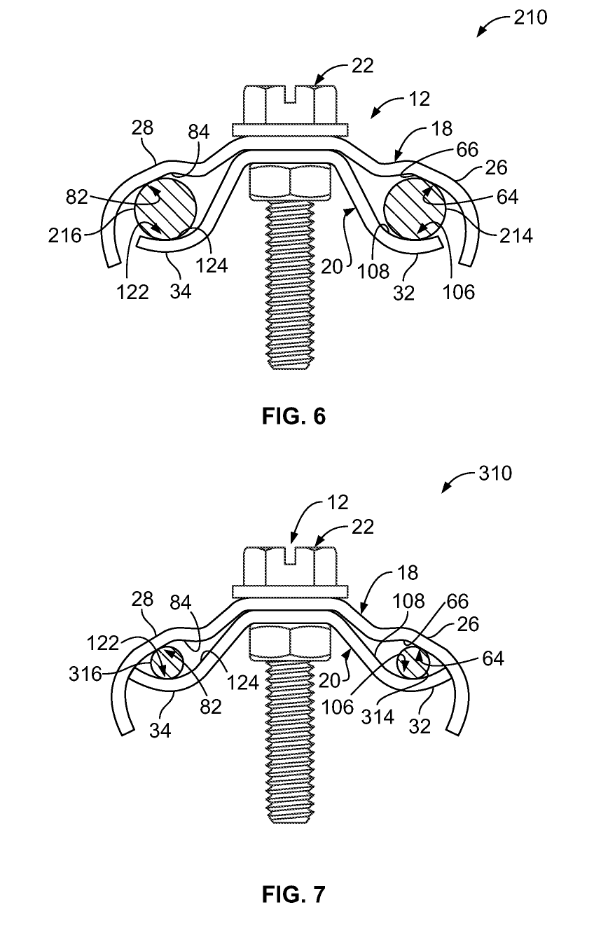

As described above, the upper and lower tap conductor arms 26 and 32, respectively, are configured to clamp a range of differently sized tap conductors, and the upper and lower main conductor arms 28 and 34, respectively, are configured to clamp a range of differently sized main conductors. FIG. 6 is an elevational view of an exemplary embodiment of an electrical connector assembly 210 illustrating use of the electrical connector 12 with exemplary tap and main conductors 214 and 216, respectively, that are smaller than the tap and main conductors 14 and 16, respectively. In the fully clamped position shown in FIG. 6, the tap conductor 214 is engaged between the upper and lower tap conductor arms 26 and 32, respectively, and the main conductor 216 is engaged between the upper and lower main conductor arms 28 and 34, respectively. The tap conductor 214 is engaged with the engagement surfaces 66 and 108 of the arms 26 and 32, respectively, such that the tap conductor 214 is electrically connected to the conductive members 18 and 20. The main conductor 216 is electrically connected to the conductive members 18 and 20 via the engagement of the main conductor 216 with the engagement surfaces 84 and 124 of the upper and lower main conductor arms 28 and 34, respectively. Accordingly, in the fully clamped position, the electrical connector 12 electrically connects the tap conductor 214 to the main conductor 216. The upper and lower conductive members 18 and 20, respectively, are shown in FIG. 6 after the being fully deflected by the engagement with the tap conductor 214 and the main conductor 216. As should be apparent from a comparison of FIGS. 3 and 6, each of the upper conductive member 18 and the lower conductive member 20 has substantially changed shape between the unclamped position shown in FIG. 3 and the fully clamped position shown in FIG. 6.

In the fully deflected positions, the biasing forces of the upper and lower tap conductor arms 26 and 32 impart a clamping force on the tap conductor 214. The biasing forces of the upper and lower main conductor arms 28 and 34 impart a clamping force on the main conductor 216 in the fully deflected positions. The clamping forces ensure adequate electrical connectivity between the tap conductor 214 and the main conductor 216. Additionally, the biasing forces provide some tolerance for deformation or compressibility of the tap and/or main conductors 214 and 216, respectively, over time. In the fully clamped position, each of the upper and lower tap conductor arms 26 and 32, respectively, has conformed to a size and/or shape of the tap conductor 214. The angle of the bends 56, 58, and/or 60 (FIG. 3) of the upper tap conductor arm 26 and/or the angle of the bends 100 and/or 102 (FIG. 3) of the lower tap conductor arm 32 has changed to at least partially conform the size and/or shape of the respective channel 64 and 106 to the size and/or shape of the tap conductor 214. The upper and lower tap conductor arms 26 and 32, respectively, thereby cooperate to conform to the size and/or shape of the tap conductor 214. Each of the upper and lower main conductor arms 28 and 34, respectively, has conformed to a size and/or shape of the main conductor 216. More particularly, the angle of the bends 74, 76, and/or 78 (FIG. 3) of the arm 28 and/or the angle of the bends 116 and/or 118 (FIG. 3) of the arm 34 has changed to at least partially conform the size and/or shape of the respective channel 82 and/or 122 to the size and/or shape of the main conductor 216. The upper and lower main conductor arms 28 and 34, respectively, thereby cooperate to conform to the size and/or shape of the main conductor 216.

FIG. 7 is an elevational view of an exemplary embodiment of an electrical connector assembly 310 illustrating use of the electrical connector 12 with exemplary tap and main conductors 314 and 316, respectively, that are smaller than the tap and main conductors 12 and 14, respectively. In the fully clamped position shown in FIG. 7, the tap conductor 314 is engaged between the respective engagement surfaces 66 and 108 of the upper and lower tap conductor arms 26 and 32, respectively, and the main conductor 316 is engaged between the respective engagement surfaces 84 and 124 of the upper and lower main conductor arms 28 and 34, respectively. Accordingly, in the fully clamped position, the electrical connector 12 electrically connects the tap conductor 314 to the main conductor 316. The upper and lower conductive members 18 and 20, respectively, are shown in FIG. 7 after the being fully deflected by the engagement with the tap conductor 314 and the main conductor 316. As should be apparent from a comparison of FIGS. 3 and 7, each of the upper conductive member 18 and the lower conductive member 20 has substantially changed shape between the unclamped position shown in FIG. 3 and the fully clamped position shown in FIG. 7. In the fully deflected positions, the biasing forces of the upper and lower tap conductor arms 26 and 32 impart a clamping force on the tap conductor 314, and the biasing forces of the upper and lower main conductor arms 28 and 34 impart a clamping force on the main conductor 316. The clamping forces ensure adequate electrical connectivity between the tap conductor 314 and the main conductor 316. Additionally, the biasing forces provide some tolerance for deformation or compressibility of the tap and/or main conductors 314 and 316, respectively, over time.

In the fully clamped position shown in FIG. 7, each of the upper and lower tap conductor arms 26 and 32, respectively, has conformed to a size and/or shape of the tap conductor 314. The angle of the bends 56, 58, and/or 60 (FIG. 3) of the upper tap conductor arm 26 and/or the angle of the bends 100 and/or 102 (FIG. 3) of the lower tap conductor arm 32 has changed to at least partially conform the size and/or shape of the respective channel 64 and 106 to the size and/or shape of the tap conductor 314. The upper and lower tap conductor arms 26 and 32, respectively, thereby cooperate to conform to the size and/or shape of the tap conductor 314. Each of the upper and lower main conductor arms 28 and 34, respectively, has conformed to a size and/or shape of the main conductor 316. More particularly, the angle of the bends 74, 76, and/or 78 (FIG. 3) of the arm 28 and/or the angle of the bends 116 and/or 118 (FIG. 3) of the arm 34 has changed to at least partially conform the size and/or shape of the respective channel 82 and/or 122 to the size and/or shape of the main conductor 316. The upper and lower main conductor arms 28 and 34, respectively, thereby cooperate to conform to the size and/or shape of the main conductor 316.

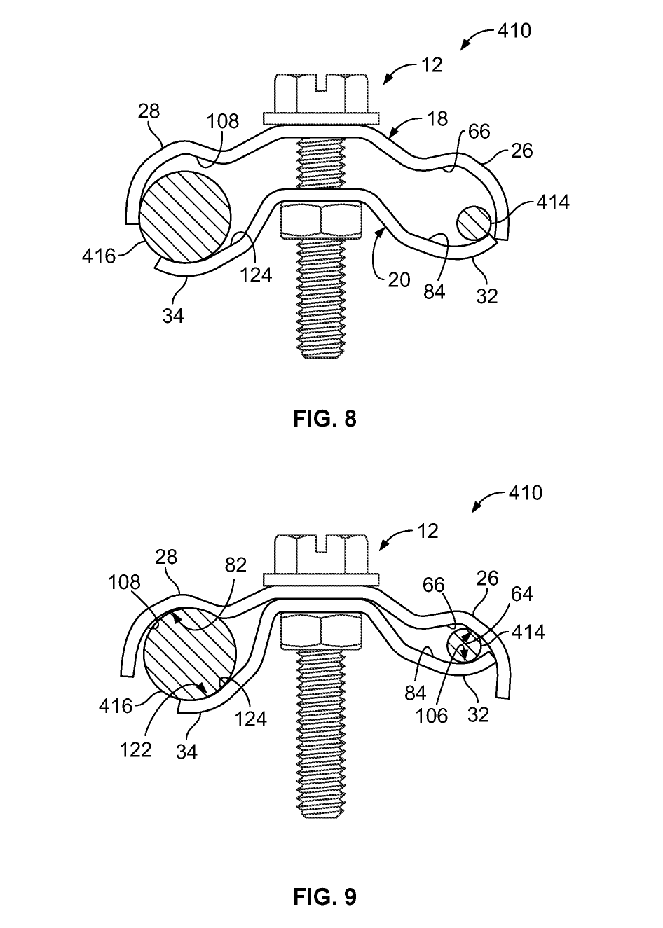

The electrical connector 12 may also be used to electrically connect a tap conductor to a main conductor that is differently sized from the tap conductor. For example, FIG. 8 is an elevational view of an exemplary embodiment of an electrical connector assembly 410 illustrating use of the electrical connector 12 with exemplary tap and main conductors 414 and 416, respectively, that have different sizes than each other. In the exemplary embodiment, the tap conductor 414 is smaller than the main conductor 416. Alternatively, the main conductor 416 is smaller than the tap conductor 414. Moreover, in another alternative embodiment, the tap conductor 414 or the main conductor 416 is replaced by a grounding rod (not shown) that is buried in the ground.

FIG. 8 illustrates the electrical connector 12 in an intermediate unclamped position. The upper and lower tap conductor arms 26 and 32 are shown in FIG. 8 after being partially deflected via engagement with each other, while the upper and lower main conductor arms 28 and 34 are shown in FIG. 8 after the being partially deflected by engagement with the main conductor 416. The movement of the arms 26 and 28 has spread the engagement surfaces 66 and 84, respectively, further apart from each other, which decreases the concavity (as viewed from the clamping side 17) of the upper conductive member 18. The movement of the arms 32 and 34 has spread the engagement surfaces 108 and 124, respectively, further apart from each other, which increases the convexity (as viewed from the clamping side 21) of the lower conductive member 20.

FIG. 9 is an elevational view of the electrical connector assembly 410 illustrating the electrical connector 12 in a fully clamped position. The tap conductor 414 is engaged between the upper and lower tap conductor arms 26 and 32, respectively, and the main conductor 416 is engaged between the upper and lower main conductor arms 28 and 34, respectively. The tap conductor 414 is engaged with the engagement surfaces 66 and 108 of the arms 26 and 32, respectively, such that the tap conductor 414 is electrically connected to the upper and lower conductive members 18 and 20, respectively. The main conductor 416 is electrically connected to the upper and lower conductive members 18 and 20, respectively, via the engagement of the main conductor 416 with the engagement surfaces 84 and 124 of the arms 28 and 34, respectively. In the fully clamped position, the electrical connector 12 electrically connects the tap conductor 414 to the main conductor 416.

The upper and lower conductive members 18 and 20, respectively, are shown in FIG. 9 after the being fully deflected by the engagement with the tap conductor 414 and the main conductor 416. As should be apparent from a comparison of FIGS. 3 and 9, each of the upper conductive member 18 and the lower conductive member 20 has substantially changed shape between the unclamped position shown in FIG. 3 and the fully clamped position shown in FIG. 9. In the fully deflected positions, the biasing forces of the upper and lower tap conductor arms 26 and 32 impart a clamping force on the tap conductor 414, and the biasing forces of the upper and lower main conductor arms 28 and 34 impart a clamping force on the main conductor 416. The clamping forces ensure adequate electrical connectivity between the tap conductor 414 and the main conductor 416. Additionally, the biasing forces provide some tolerance for deformation or compressibility of the tap and/or main conductors 414 and 416, respectively, over time.

As should be apparent from a comparison of FIGS. 3 and 9, in the fully clamped position, each of the upper and lower tap conductor arms 26 and 32, respectively, has conformed to a size and/or shape of the tap conductor 414. Specifically, the angle of the bends 56, 58, and/or 60 (FIG. 3) of the upper tap conductor arm 26 has changed to at least partially conform the size and/or shape of the channel 64 to the size and/or shape of the tap conductor 414. The angle of the bends 100 and/or 102 (FIG. 3) of the lower tap conductor arm 32 has changed to at least partially conform the size and/or shape of the channel 106 to the size and/or shape of the tap conductor 414. The upper and lower tap conductor arms 26 and 32, respectively, thereby cooperate to conform to the size and/or shape of the tap conductor 414. Similar to the arms 26 and 32, each of the upper and lower main conductor arms 28 and 34, respectively, has conformed to a size and/or shape of the main conductor 416. More particularly, the angle of the bends 74, 76, and/or 78 (FIG. 3) of the arm 28 has changed to at least partially conform the size and/or shape of the channel 82 to the size and/or shape of the main conductor 416, and the angle of the bends 116 and/or 118 (FIG. 3) of the arm 34 has changed to at least partially conform the size and/or shape of the channel 122 to the size and/or shape of the main conductor 416. The upper and lower main conductor arms 28 and 34, respectively, thereby cooperate to conform to the size and/or shape of the main conductor 416.

It is therefore believed that the electrical connector 12 provides the performance of at least some known electrical connectors in a lower cost connector that does not require specialized tooling and a large inventory of parts to meet installation needs. The electrical connector 12 may be installed with hand tools instead of specialized tooling, such as explosive cartridges or pressing tools. The electrical connector 12 provides a reliable and consistent clamping force on the tap and main conductors and is less subject to variability of clamping force when installed than at least some known electrical connectors. Unlike at least some known electrical connectors, the electrical connector 12 is stable, repeatable, and consistently applied to the conductors, and the quality of the mechanical and electrical connection is not as dependent on torque requirements and/or relative skill of the installer. Additionally, and unlike at least some known electrical connectors, the electrical connector 12 may compensate for relative compressible deformation or movement of the tap and/or main conductors.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

1. An electrical connector for power conductors including a main conductor and a tap conductor, said electrical connector comprising:
an upper conductive member comprising an upper tap conductor arm configured to engage the tap conductor and an upper main conductor arm configured to engage the main conductor, each of the upper tap conductor arm and the upper main conductor arm comprising a deflectable spring; and
a lower conductive member separately fabricated from the upper conductive member, the lower conductive member comprising a lower tap conductor arm configured to engage the tap conductor and a lower main conductor arm configured to engage the main conductor, each of the lower tap conductor arm and the lower main conductor arm comprising a deflectable spring, wherein the upper and lower tap conductor arms oppose each other and are configured to clamp the tap conductor therebetween, and wherein the upper and lower main conductor arms oppose each other and are configured to clamp the main conductor therebetween.

2. The electrical connector according to claim 1, wherein the upper and lower conductive members comprise upper and lower central plates, respectively, the upper tap and main conductor arms extending outwardly from opposite edges of the upper central plate, the lower tap and main conductor arms extending outwardly from opposite edges of the lower central plate.

3. The electrical connector according to claim 1, wherein the upper and lower tap conductor arms are movable from normal positions to deflected positions via engagement with the tap conductor, the upper and lower tap conductor arms imparting a clamping force on the tap conductor in the deflected positions, and wherein the upper and lower main conductor arms are movable from normal positions to deflected positions via engagement with the main conductor, the upper and lower main conductor arms imparting a clamping force on the main conductor in the deflected positions.

4. The electrical connector according to claim 1, wherein the upper tap and main conductor arms of the upper conductive member comprise engagement surfaces that are configured to engage the tap and main conductors, respectively, the engagement surfaces of the upper tap and main conductor arms being configured to be spread further apart from each other via engagement with the tap and main conductors, respectively, during clamping of the tap and main conductors between the upper and lower conductive members.

5. The electrical connector according to claim 1, wherein the lower tap and main conductor arms of the lower conductive member comprise engagement surfaces that are configured to engage the tap and main conductors, respectively, the engagement surfaces of the lower tap and main conductor arms being configured to be spread further apart from each other via engagement with the tap and main conductors, respectively, during clamping of the tap and main conductors between the upper and lower conductive members.

6. The electrical connector according to claim 1, wherein the upper and lower conductive members comprise upper and lower central plates, respectively, the upper tap and main conductor arms extending outwardly from the upper central plate at corresponding upper intersections, the upper tap and main conductor arms being movable relative to the upper central plate along arcs centered at the corresponding upper intersections, the lower tap and main conductor arms extending outwardly from lower central plate at corresponding lower intersections, the lower tap and main conductor arms being movable relative to the lower central plate along arcs centered at the corresponding lower intersections.

7. The electrical connector according to claim 1, wherein at least one of:
the upper tap conductor arm and the lower tap conductor arm are configured to conform to a size and shape of the tap conductor via engagement with the tap conductor; or
the upper main conductor arm and the lower main conductor arm are configured to conform to a size and shape of the main conductor via engagement with the main conductor.

8. The electrical connector according to claim 1, wherein the upper and lower conductive members comprise upper and lower central plates, respectively, the upper tap and main conductor arms extending outwardly from the upper central plate, the lower tap and main conductor arms extending outwardly from the lower central plate, the upper and lower central plates being engaged with each other when the tap and main conductors are clamped between the upper and lower conductive members.

9. The electrical connector according to claim 1, wherein at least one of the upper conductive member or the lower conductive member are stamped and formed from at least one of a sheet or a reel of material.

10. The electrical connector according to claim 1, wherein the upper and lower conductive members comprise upper and lower central plates, respectively, the upper tap and main conductor arms extending outwardly from the upper central plate, the lower tap and main conductor arms extending outwardly from the lower central plate, the upper and lower central plates comprising openings, the assembly further comprising a threaded fastener received through the openings within the upper and lower central plates, wherein tightening of the fastener draws the upper and lower conductive members toward each other.

11. The electrical connector according to claim 1, wherein at least one of:
the upper tap conductor arm comprises a channel configured to receive the tap conductor therein;
the lower tap conductor arm comprises a channel configured to receive the tap conductor therein;
the upper main conductor arm comprises a channel configured to receive the main conductor therein; or
the lower main conductor arm comprises a channel configured to receive the main conductor therein.

12. The electrical connector according to claim 1, wherein at least one of the upper tap conductor arm, the lower tap conductor arm, the upper main conductor arm, or the lower main conductor arm is configured to clamp conductors having a range of different sizes.

13. The electrical connector according to claim 1, wherein at least one of the upper conductive member or the lower conductive member comprises a substantially uniform thickness.

14. An electrical connector for power conductors including a main conductor and a tap conductor, said electrical connector comprising:
an upper conductive member comprising an upper tap conductor arm configured to engage the tap conductor and an upper main conductor arm configured to engage the main conductor, each of the upper tap conductor arm and the upper main conductor arm comprising a deflectable spring;
a lower conductive member separately fabricated from the upper conductive member, the lower conductive member comprising a lower tap conductor arm configured to engage the tap conductor and a lower main conductor arm configured to engage the main conductor, wherein the upper and lower tap conductor arms oppose each other and are configured to clamp the tap conductor therebetween, and wherein the upper and lower main conductor arms oppose each other and are configured to clamp the main conductor therebetween; and
a threaded fastener connecting the upper and lower conductive members.

15. The electrical connector according to claim 14, wherein the upper and lower conductive members comprise upper and lower central plates, respectively, the upper tap and main conductor arms extending outwardly from opposite edges of the upper central plate, the lower tap and main conductor arms extending outwardly from opposite edges of the lower central plate, the threaded fastener extending through the upper and lower central plates.

16. The electrical connector according to claim 14, wherein the upper and lower conductive members comprise upper and lower central plates, respectively, the upper tap and main conductor arms extending outwardly from the upper central plate, the lower tap and main conductor arms extending outwardly from the lower central plate, the upper and lower central plates comprising openings, the threaded fastener being received through the openings within the upper and lower central plates, wherein tightening of the threaded fastener draws the upper and lower conductive members toward each other.

17. The electrical connector according to claim 14, wherein the upper tap and main conductor arms are movable from normal positions to deflected positions via engagement with the tap and conductors, respectively, the upper tap and main conductor arms imparting a clamping force on the tap and main conductors, respectively, in the deflected positions.

18. The electrical connector according to claim 14, wherein the upper and lower conductive members comprise upper and lower central plates, respectively, the upper tap and main conductor arms extending outwardly from the upper central plate, the lower tap and main conductor arms extending outwardly from the lower central plate, the upper and lower central plates being engaged with each other when the tap and main conductors are clamped between the upper and lower conductive members.

19. The electrical connector according to claim 14, wherein at least one of:
the upper tap conductor arm comprises a channel configured to receive the tap conductor therein;
the lower tap conductor arm comprises a channel configured to receive the tap conductor therein;
the upper main conductor arm comprises a channel configured to receive the main conductor therein; or
the lower main conductor arm comprises a channel configured to receive the main conductor therein.

20. The electrical connector according to claim 14, wherein at least one of the upper tap conductor arm, the lower tap conductor arm, the upper main conductor arm, or the lower main conductor arm is configured to clamp conductors having a range of different sizes.

21. The electrical connector according to claim 1, wherein the upper and lower tap conductor arms are configured to engage a tap conductor having a first size, and the upper and lower main conductor arms are configured to engage a main conductor having a second size that is different than the first size.
